(19) United States
(12) Patent Application Publication
(10) Pub. No.: US 2015/0331219 A1
(43) Pub. Date: Nov. 19, 2015

(54) LENS ASSEMBLY

(71) Applicant: CALIN TECHNOLOGY CO., LTD., Taichung City (TW)

(72) Inventors: Chun-Ming CHEN, Taichung City (TW); Kuo-Chin HUNG, Taichung City (TW)

(73) Assignee: CALIN TECHNOLOGY CO., LTD., Taichung City (TW)

(21) Appl. No.: 14/279,130

(22) Filed: May 15, 2014

(51) Int. Cl. G02B 7/02

(52) U.S. Cl. CPC G02B 7/021

(57) ABSTRACT

A lens assembly includes a lens barrel, a first lens, a second lens, and a third lens. The first lens is provided in the lens barrel with an outer periphery abutting against an inner wall of the lens barrel. The second lens abuts against the first lens, and there is a spacing formed between the second lens and the inner wall of the lens barrel. The third lens abuts against the second lens, and there is another spacing formed between the third lens and the inner wall of the lens barrel. With abutment relations of these lenses, relative positions between each lens can be fixed, and therefore the influence of allowable tolerance of the lens barrel upon optical performance is greatly reduced.

### BACKGROUND OF THE INVENTION

1. Field of the Invention

The present invention relates generally to optics devices, and more particularly to a lens assembly.

2. Description of the Related Art

With the advances in optical technology, optical devices such as cameras, camcorders, and projectors are getting more and more popular. Optical performance of such optical devices is highly dependent on their lens assemblies. In this view, lens assembly can be considered the most important component of any optical device.

A lens assembly typically includes a lens barrel and a series of lenses installed inside the barrel. If any of the lenses is installed inaccurately to affect the relative positions between the lenses, the optical performance of the lens assembly may not be as expected. In other words, minimizing the errors at installing the lenses is critical to manufacture lens assembly of designed optical performance.

Generally, the allowable tolerance of the inner diameter of a lens barrel is around 0.005 mm in the industry. However, since the lens assembly becomes more miniature, such allowable tolerance is eventually insufficient to ensure the relative positions between lenses, and therefore the optical performance of a miniature lens assembly may fail to meet the requirement of users.

### SUMMARY OF THE INVENTION

The primary objective of the present invention is to provide a lens assembly, of which the relative positions of the lenses therein are not affected by the allowable tolerance of the inner diameter of a lens barrel, and therefore the influence of such allowable tolerance upon optical performance is greatly reduced.

According to the objective of the present invention, the present invention provides a lens assembly, which includes a lens barrel, a first lens, a second lens, and a third lens. The lens barrel has an object-side opening and an image-side opening opposite to the object-side opening. The first lens is provided in the lens barrel, wherein the first lens has an outer periphery abutting against an inner wall of the lens barrel to fix a radial relative position between the first lens and the lens barrel; the first lens further has a first surface facing the object-side opening and a second surface facing the image-side opening; the first surface has a first lens portion at a center thereof; the second surface has a second lens portion at a center thereof, and a second locating portion and a second reference portion which together surround the second lens portion The second lens is provided in the lens barrel, wherein the second lens has a third surface facing the object-side opening and a fourth surface facing the image-side opening; the third surface has a third lens portion at a center thereof, and a third locating portion and a third reference portion which together surround the third lens portion; the third locating portion abuts against the second locating portion to fix a radial relative position between the third surface and the second surface, and to leave a spacing between the second lens and the inner wall of the lens barrel; the third reference portion abuts against the second reference portion to fix an axial relative position between the third surface and the second surface; the fourth surface has a fourth lens portion at a center thereof, and a fourth locating portion and a fourth reference portion which together surround the fourth lens portion. The third lens is provided in the lens barrel, wherein the third lens has a fifth surface facing the object-side opening and a sixth surface facing the image-side opening; the fifth surface has a fifth lens portion at a center thereof, and a fifth locating portion and a fifth reference portion which together surround the fifth lens portion; the fifth locating portion abuts against the fourth locating portion to fix a radial relative position between the fifth surface and the fourth surface, and to leave a spacing between the third lens and the inner wall of the lens barrel; the fifth reference portion abuts against the fourth reference portion to fix an axial relative position between the fifth surface and the fourth surface.

With abutment relations of these lenses, relative positions between each lens can be avoided from being affected by allowable tolerance of an inner diameter of the lens barrel during an assembling process of manufacturing the lens assembly. Therefore, the influence of allowable tolerance of the lens barrel upon optical performance is greatly reduced.

### BRIEF DESCRIPTION OF THE DRAWINGS

FIG. 1 is a perspective view of a preferred embodiment of the present invention;

FIG. 2 is an exploded view of the preferred embodiment of the present invention; and

FIG. 3 is a sectional view along the A-A line in FIG. 1.

### DETAILED DESCRIPTION OF THE INVENTION

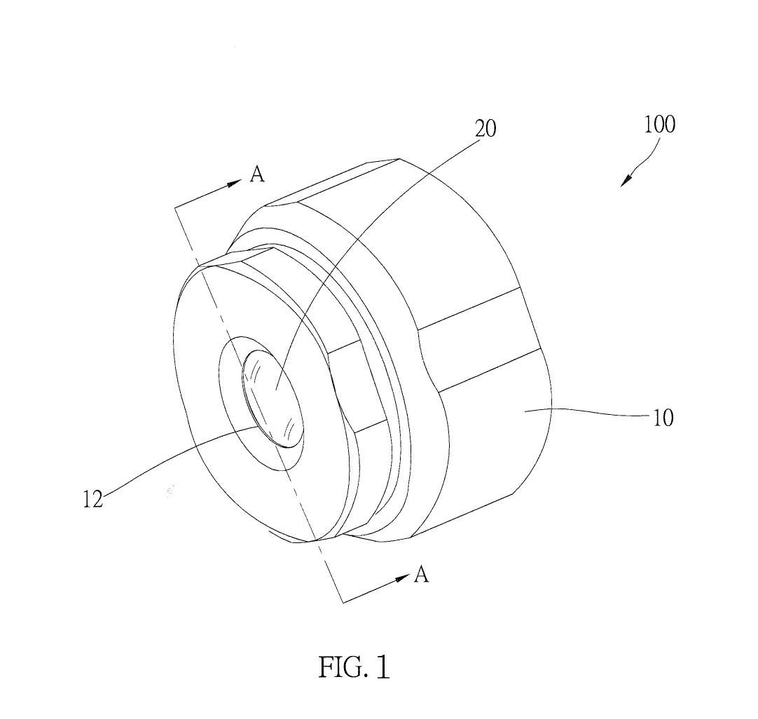

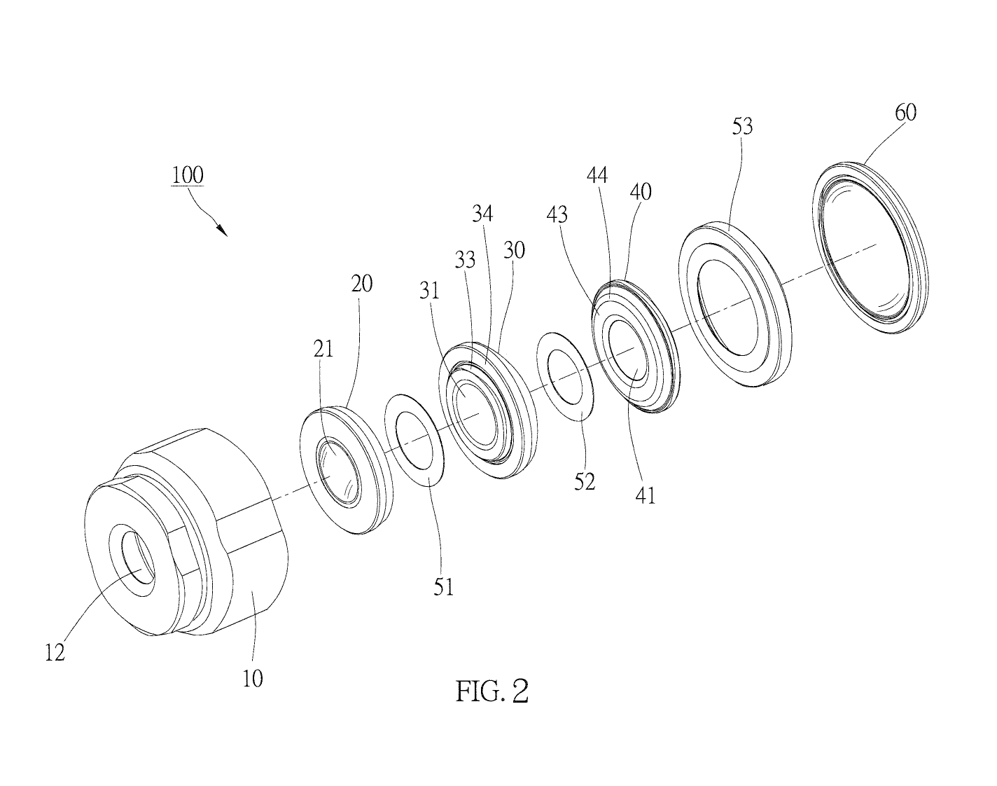

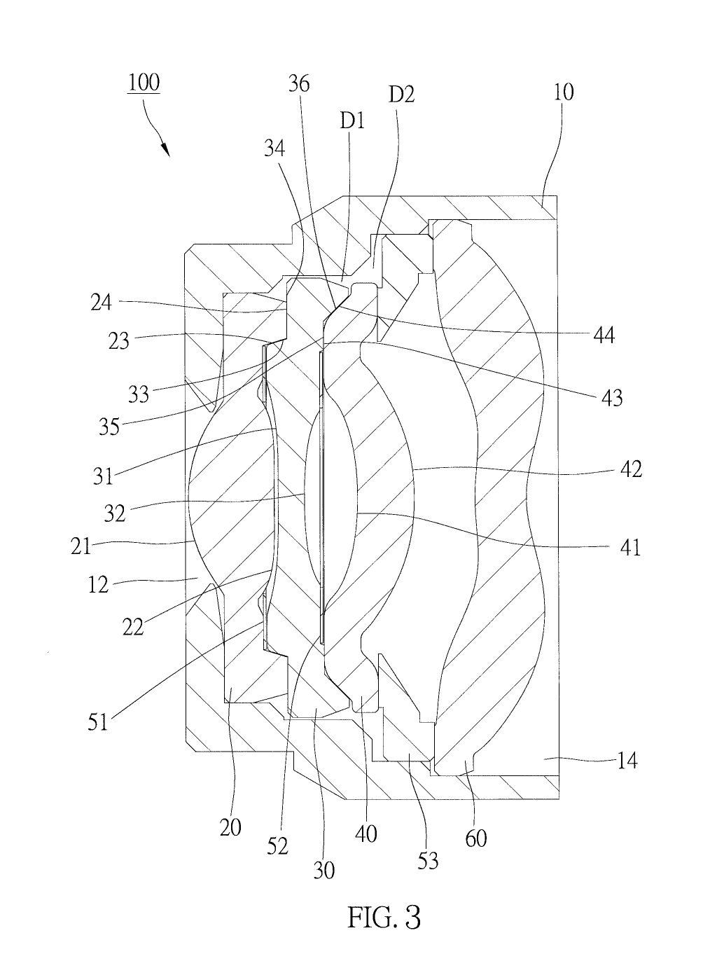

As shown in FIG. 1 to FIG. 3, the lens assembly 100 of the preferred embodiment of the present invention includes a lens barrel 10, a first lens 20, a second lens 30, a third lens 40, two shade rings 51, 52, a securing ring 53, and a fourth lens 60.

The lens barrel 10 is a hollow cylinder, and has an object-side opening 12 and an image-side opening 14 at opposite ends to communicate with an inner space in the lens barrel 10.

The first lens 20 is provided in the lens barrel 10, wherein the first lens 20 has a first surface facing the object-side opening 12 and a second surface facing the image-side opening 14. The first surface has a first lens portion 21 at a center thereof. The second surface has a second lens portion 22 at a center thereof, and a second locating portion 23 and a second reference portion 24 which together surround the second lens portion 22, wherein the second locating portion 23 is closer to the second lens portion 22 than the second reference portion 24, and the second locating portion 23 has an inclined plane in the preferred embodiment. Besides, an outer periphery of the first lens 20 abuts against an inner wall of the lens barrel 10 to fix a radial relative position between the first lens 20 and the lens barrel 10. Moreover, a position where the first lens 20 is in the lens barrel 10 is fixed by abutting the first surface against the inner wall of the lens barrel 10.

The shade rings 51, 52 are made of a light-tight material, and are in a shape of a circular ring, wherein the shade rings 51, 52 respectively have a hole at a center thereof.

The second lens 30 is provided in the lens barrel 10, wherein the second lens 30 has a third surface facing the object-side opening 12 and a fourth surface facing the image-side opening 14. The third surface has a third lens portion 31 at a center thereon, and a third locating portion 33 and a third reference portion 34 which together surround the third lens portion 31, wherein the third locating portion 33 is closer to the third lens portion 31 than the third reference portion 34. The third locating portion 33 has an inclined plane in the preferred embodiment, and an inclined angle thereof is complementary with an inclined angle of the inclined plane of the second locating portion 23. Besides, the fourth surface has a fourth lens portion 32 at a center thereon, and a fourth reference portion 35 and a fourth locating portion 36 which together surround the fourth lens portion 32, wherein the fourth reference portion 35 is closer to the fourth lens portion 32 than the fourth locating portion 36. In the preferred embodiment, the fourth locating portion 36 also has an inclined plane, and surfaces of the fourth reference portion 35 and the third reference portion 34 are substantially parallel to each other.

In this way, while assembling the lens assembly 100, the shade ring 51 is placed on the second surface of the first lens 20 with its hole being aligned with the second lens portion 22. And then, the third locating portion 33 and the second locating portion 23 abut against each other to restrict the second lens 30 with the first lens 20. A radial relative position between the third surface and the second surface is therefore fixed. A spacing D1 is left between the second lens 30 and the inner wall of the lens barrel 10, so that the second lens 30 does not contact the lens barrel 10. The third reference portion 34 abuts against the second reference portion 24 to fix an axial relative position between the third surface and the second surface, and the shade ring 51 is therefore between the first lens 20 and the second lens 30.

The third lens 40 is provided in the lens barrel 10, wherein the third lens 40 has a fifth surface facing the object-side opening 12 and a sixth surface facing the image-side opening 14. The fifth surface has a fifth lens portion 41 at a center thereof, and a fifth reference portion 43 and a fifth locating portion 44 which together surround the fifth lens portion 41, wherein the fifth reference portion 43 is closer to the fifth lens portion 41 than the fifth locating portion 44. The fifth locating portion 44 has an inclined plane in the preferred embodiment, and an inclined angle thereof is complementary with an inclined angle of the inclined plane of the fourth locating portion 36. The sixth surface has a sixth lens portion 42 at a center thereof.

In this way, while assembling the lens assembly 100, the shade ring 52 is placed on the fourth surface of the second lens 30 with its hole being aligned with the fourth lens portion 32. And then, fifth locating portion 44 and the fourth locating portion 36 abut against each other to restrict the third lens 40 with the second lens 30. A radial relative position between the fifth surface and the fourth surface is therefore fixed. A spacing D2 is left between the third lens 40 and the inner wall of the lens barrel 10, so that the third lens 40 does not contact the lens barrel 10. The fifth reference portion 43 abuts against the fourth reference portion 34 to fix an axial relative position between the fifth surface and the fourth surface, and the shade ring 52 is therefore between the second lens 30 and the third lens 40.

The securing ring 53 is made of a hard material, and is in a shape of a circular ring, wherein the securing ring 53 has a hole at a center thereof. After the first lens 20, the second lens 30, and the third lens 40 are assembled into the lens barrel 10, the securing ring 53 is received in the lens barrel 10 and attached to the sixth surface of the third lens 40 with its hole being aligned with the sixth lens portion 42. The hole of the securing ring 53 allows light to pass through, and therefore the lenses 20, 30, 40 can be fixed in the lens barrel 10 without affecting an optical performance of the lens assembly 100.

The fourth lens 60 is provided in the lens barrel 10, and is closer to the image-side opening 14 than the securing ring 53, wherein the fourth lens 60 abuts against the securing ring 53, and the securing ring 53 is therefore between the third lens 40 and the fourth lens 60. The fourth lens 60 is provided to reduce aberration, and to enhance the optical performance of the lens assembly 100.

With the aforementioned design, the relative positions between the lenses 20, 30, 40 are firmly secured by abutment relations between each lens 20, 30, 40. As a result, an allowable tolerance of an inner diameter of the lens barrel 10 does not affect the relative positions between the lenses 20, 30, 40, and errors of the relative positions can be lowered to be less than 0.002 mm, which greatly improves the optical performance of the lens assembly 100.

In practice, of course, the locating portions and the reference portions are not restricted at their positions disclosed in the preferred embodiment. It must be pointed out that the embodiment described above is only one of the preferred embodiments of the present invention. All equivalent structures which employ the concepts disclosed in this specification and the appended claims should fall within the scope of the present invention.

What is claimed is:

1. A lens assembly, comprising:
a lens barrel, which has an object-side opening and an image-side opening opposite to the object-side opening;
a first lens provided in the lens barrel, wherein the first lens has an outer periphery abutting against an inner wall of the lens barrel to fix a radial relative position between the first lens and the lens barrel; the first lens further has a first surface facing the object-side opening and a second surface facing the image-side opening; the first surface has a first lens portion at a center thereof; the second surface has a second lens portion at a center thereof, and a second locating portion and a second reference portion which together surround the second lens portion;
a second lens provided in the lens barrel, wherein the second lens has a third surface facing the object-side opening and a fourth surface facing the image-side opening; the third surface has a third lens portion at a center thereof, and a third locating portion and a third reference portion which together surround the third lens portion; the third locating portion abuts against the second locating portion to fix a radial relative position between the third surface and the second surface, and to leave a spacing between the second lens and the inner wall of the lens barrel; the third reference portion abuts against the second reference portion to fix an axial relative position between the third surface and the second surface; the fourth surface has a fourth lens portion at a center thereof, and a fourth locating portion and a fourth reference portion which together surround the fourth lens portion; and
a third lens provided in the lens barrel, wherein the third lens has a fifth surface facing the object-side opening and a sixth surface facing the image-side opening; the fifth surface has a fifth lens portion at a center thereof, and a fifth locating portion and a fifth reference portion which together surround the fifth lens portion; the fifth locating portion abuts against the fourth locating portion to fix a radial relative position between the fifth surface and the fourth surface, and to leave a spacing between the third lens and the inner wall of the lens barrel; the fifth reference portion abuts against the fourth reference portion to fix an axial relative position between the fifth surface and the fourth surface.

2. The lens assembly as defined in claim 1, wherein the second locating portion is closer to the second lens portion than the second reference portion, while the third locating portion is closer to the third lens portion than the third reference portion.

3. The lens assembly as defined in claim 1, wherein the second locating portion and the third locating portion respectively have an inclined plane, wherein inclined angles of the inclined planes of the second locating portion and the third locating portion are complementary.

4. The lens assembly as defined in claim 1, wherein the fourth reference portion is closer to the fourth lens portion than the fourth locating portion, while the fifth reference portion is closer to the fifth lens portion than the fifth locating portion.

5. The lens assembly as defined in claim 1, wherein the fourth locating portion and the fifth locating portion respectively have an inclined plane, wherein inclined angles of the inclined planes of the fourth locating portion and the fifth locating portion are complementary.

6. The lens assembly as defined in claim 1, wherein surfaces of the third reference portion and the fourth reference portion are substantially parallel to each other.

7. The lens assembly as defined in claim 1, further comprising a shade ring provided in the lens barrel between the first lens and the second lens, wherein the shade ring is made of a light-tight material.

8. The lens assembly as defined in claim 1, further comprising a shade ring provided in the lens barrel between the second lens and the third lens, wherein the shade ring is made of a light-tight material.

9. The lens assembly as defined in claim 1, further comprising a securing ring provided in the lens barrel, wherein the securing ring is closer to the image-side opening than the third lens, and abuts against the sixth surface.

10. The lens assembly as defined in claim 9, further comprising a fourth lens provided in the lens barrel, wherein the fourth lens is closer to the image-side opening than the securing ring, and abuts against the securing ring.
